(19) United States
(12) Patent Application Publication
(10) Pub. No.: US 2026/0080169 A1
(43) Pub. Date: Mar. 19, 2026

(54) SIZE CONSTRAINED TEXT GENERATION WITH LARGE LANGUAGE MODELS

(71) Applicant: Dell Products L.P., Round Rock, TX (US)

(72) Inventors: David Burth Kurka, Campinas (BR); Victor da Cruz Ferreira, Rio de Janeiro (BR); Vinicius Michel Gottin, Rio de Janeiro (BR)

(21) Appl. No.: 18/889,208

(22) Filed: Sep. 18, 2024

(51) Int. Cl. G06F 40/284; G06F 40/40

(52) U.S. Cl. CPC G06F 40/284; G06F 40/40

(57) ABSTRACT

One example method includes receiving a set of input tokens, generating, using a text generation LM, respective first probabilities, for each of the input tokens, that the input token will be a next token in a text string, selecting, based on the respective first probabilities, a set of candidate tokens from the set of input tokens, inputting the candidate tokens to a distance model, generating, by the distance model, respective second probabilities for each of the candidate tokens, where each of the second probabilities is a probability that a corresponding one of the candidate tokens can be added to the text string without exceeding a token budget for that text string, performing, using the first probabilities and the second probabilities, a scoring phase to compute a score for each of the candidate tokens, and selecting the token with a highest score to be added as the next token in the text string.

### TECHNOLOGICAL FIELD OF THE DISCLOSURE

Embodiments disclosed herein generally relate to large language models (LLMs). More particularly, at least some embodiments relate to systems, hardware, software, computer-readable media, and methods, for generating size constrained text by an LLM.

### BACKGROUND

Since the recent popularization of Generative AI algorithms for text generation, such as ChatGPT, Bard, and Microsoft Co-pilot, for example, many applications are being developed for the use of such generative AI algorithms. A state-of-the-art method for text generation is the use of transformer-based LLMs. These models show an ability to understand human instructions, generate coherent text and perform reasoning tasks from users prompts.

However, an important feature lacking on current models is the ability to constrain the output of an LLM, that is, the generated text, to a specific predetermined length in tokens while also maintaining sentence coherence. Currently, external libraries provide text generation algorithms and APIs that accept many hyper-parameters such as temperature, sampling methods, and repetition penalty. Many of these also enable a user to define a number for maximum tokens generated. However, this value is a hard-stop which cuts off the text generation process in the middle once the budget is hit. Thus, conventional approaches provide no guarantee that the generated text will be coherent, since the text generation may be terminated mid-sentence so as to comply with a specified budget.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an generic text-generation pipeline.

FIG. 2 discloses aspects of a text-generation pipeline according to one embodiment.

FIG. 3 discloses an example application of one embodiment that involves the use of 3 candidate last tokens passing through distance models, and producing probabilities.

FIG. 4 discloses aspects of an approach employed by one embodiment for scoring, that is, determining which token will be the next in a text string such as a sentence.

FIG. 5 discloses an example application of one embodiment.

FIG. 6 discloses a computing entity configured and operable to perform any of the disclosed methods, processes, and operations.

### DETAILED DESCRIPTION OF SOME EXAMPLE EMBODIMENTS

Embodiments disclosed herein generally relate to large language models (LLMs). More particularly, at least some embodiments relate to systems, hardware, software, computer-readable media, and methods, for generating size constrained text by an LLM.

One or more embodiments concern architectures, methods, and LLMs, for enabling text generated by LLMs to stay within, or near, a token budget limit, while also finishing the text generation gracefully, that is, in a way that maintains sentence, or other text string, coherence notwithstanding compliance with the token budget. One example of such a method comprises operations including: receiving a set of input tokens; generating, using a text generation LM (language model), respective first probabilities, for each of the input tokens, that the input token will be the next token in a text string; selecting, based on the respective first probabilities, a set of candidate tokens from the set of input tokens; inputting the candidate tokens to a distance model; generating, by the distance model, respective second probabilities for each of the candidate tokens, where each of the second probabilities is a probability that the corresponding candidate token can be added to the text string without exceeding a token budget for that text string; performing, using the first probabilities and the second probabilities, a scoring phase to compute, for each of the candidate tokens, a score; and selecting the token with a highest score to be added as the next token in the text string.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of one embodiment is that an embodiment may enable text generated by a text generation LLM to remain in, or near, a token budget limit, while also finishing the text generation gracefully, that is, in a way that maintains sentence, or other text string, coherence notwithstanding compliance with the token budget. An embodiment may be widely applicable to a variety of applications including, but not limited to, chatbots, intelligent assistants, copilots, or any other text generation LLM and/or next-token selection approach. Various other advantages of one or more example embodiments will be apparent from this disclosure.

### A. ASPECTS OF AN EXAMPLE CONTEXT FOR ONE EMBODIMENT

The following is a discussion of aspects of an example context for one embodiment. This discussion is not intended to limit the scope of the claims or this disclosure, or the applicability of the embodiments, in any way.

### A.1 Text-Generation Pipeline

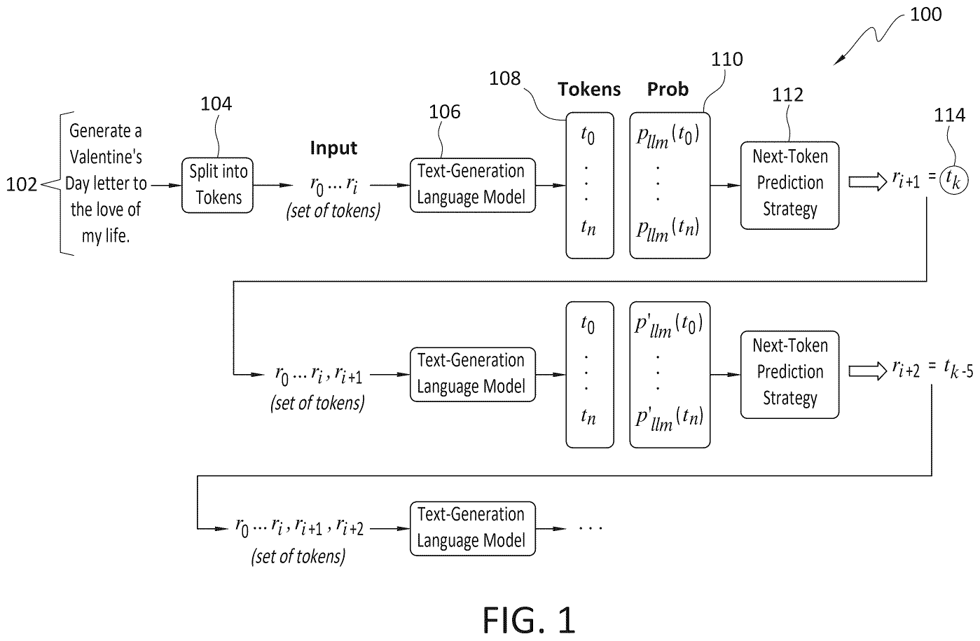

With attention now to FIG. 1, aspects of a generic text-generation pipeline 100 are disclosed. As shown there, a sentence 102 will initially be transformed into tokens 104, and then into embeddings. The embeddings will be processed by a text-generation language model 106 which may output a SoftMax of all available tokens 108 and their respective probabilities 110.

A next-token prediction strategy (NTPS) 112 may then review these probabilities 110 and select the next token 114 to be appended to the sentence 102. In the example, token tₖ is selected as the next token 114. This token 114 will then be appended to the sentence 102 and the operations of the pipeline 100 will repeat.

The stop criterion may comprise a special token such as <EOS> (End-of-Sentence) selected by the NTPS. In general, many APIs also offer support to just stop the text generation process once a user-defined token limit, or budget, has been reached. In contrast, one embodiment comprises a modification and improvement of the generic pipeline 100, so the selected tokens are more likely to lead towards a <EOS> to finish the generation as the process nears the user-defined token limit.

### A.2 NTPS

The NTPS is an algorithm that, given a set of probabilities outputted by the Text-Generation Language Model, will define which token will be selected next. The most naïve strategy, which is used in conventional classification processes, is the ‘greedy decoding’ strategy, which selects the token with highest probability. However, this strategy may produce numerous repetitive words, and less diversity, when forming sentences. Therefore, other algorithms may be better suited in some circumstances. In contrast with the greedy approach, some conventional techniques define a sampling strategy that will allow for additional exploration of tokens while respecting the probability distribution outputted by the model. More information on these techniques can be found at “Hugging Face Text Generation Strategies—Decoding Strategies: https://huggingface.co/docs/transformers/generation_strategies#decoding-strategies” which is incorporated herein in its entirety by this reference.

### B. OVERVIEW OF ASPECTS OF ONE EMBODIMENT

One embodiment comprises an approach to enable text generated by LLMs to stay around the budget limit while finishing the generation gracefully, maintaining sentence coherence. An embodiment may be useful in several applications, including, but not limited to, in chatbots, intelligent assistants and copilots. Having a reliable and consistent way to guarantee that a text generated by an LLM can simultaneously fit within a budget and be complete is a significant advantage that is not achievable using current approaches.

One example embodiment comprises a modification and improvement of a next token selection process of Text Generation LLMs to support completing a sentence given a user-defined maximum answer token budget without losing sentence coherence. One embodiment may comprise a generic modular process which can be attached to any generation LLM or next-token selection strategy.

By way of comparison, in a conventional text-generation inference pipeline, a text-generation model produces probabilities (pₗₗₘ) to every token available on its dictionary. In general, an NTPS is then applied, leveraging those probabilities, to select the next token in a sentence, as discussed elsewhere herein.

Thus, one embodiment comprises a modification and improvement of the next-token prediction approach so that the modified approach returns a set of candidate tokens which will be fed into a language model (LM) M_{d}. The model may be trained offline to predict a probability (p_{d}) that a given token can be added to a text string, while still respecting a given token budget b in the current text string.

In one embodiment, a scoring phase may calculate a score over the pₗₗₘ and p_{d} of each candidate token separately. The calculation leverages the remaining budget percentage to inform the next token strategy candidate choice. The highest scoring token will be selected as the next token to move the text generation pipeline forward. This process may be performed iteratively until the token budget is met, or exceeded by a permissible percentage such as 5 percent for example.

In an embodiment, the scoring phase will tend to prioritize tokens that are more meaningful for the text sequence when the budget is high, and prioritize tokens that are more likely to complete the text generation pipeline when the budget is near exhaustion. In one embodiment, the token budget may be deemed to be near exhaustion when the number of texts in the sentence is in a range of 85 percent to 90 percent, inclusive, of the token budget.

As apparent from the foregoing, and the rest of this disclosure, one embodiment comprises a modular approach that can be used to constrain text generation into a user-specified answer budget while maintaining sentence coherence. In one embodiment, this may be achieved through processes such as, but not limited to, a training and inference process that leverages a machine learning model to predict the distance between a partial sentence and the end of the sentence, and a next token selection process to improve the likelihood that the user-specified answer budget will be respected. By way of contrast with one or more embodiments, conventional approaches do not focus on respecting answer token budget while also maintaining sentence coherence.

### C. DETAILED DISCUSSION

One embodiment comprises an approach for size-constraining text generation in next-token prediction LMs. Conventional text-generation strategies focus solely on selecting the better next token to improve quality. If a user would like to limit text generation content, the two main approaches consist of explicitly telling the text-generation LM through context, or by abruptly stopping the generation once the user defined token limit is reached. In general, the latter tends to form incoherent sentences with abrupt stops, while the former performs better when limited by different metrics such as paragraphs instead of tokens and the constraint is still subjected to being completely ignored by the model.

Typical backends and API calls to text-generation models have a built-in or available limiting options by token, usually using abrupt stops for security and optimization reasons. Therefore, an approach, example embodiments of which are disclosed herein, that respects said budget, in tokens, while maintaining sentence coherence will benefit several frameworks with improved text-generation quality. Further, one embodiment offers a solution that can leverage any of the most popular next-token prediction strategies by providing a smooth stop that tends to respect the user defined token limit while also maintaining sentence coherence notwithstanding compliance with that token limit.

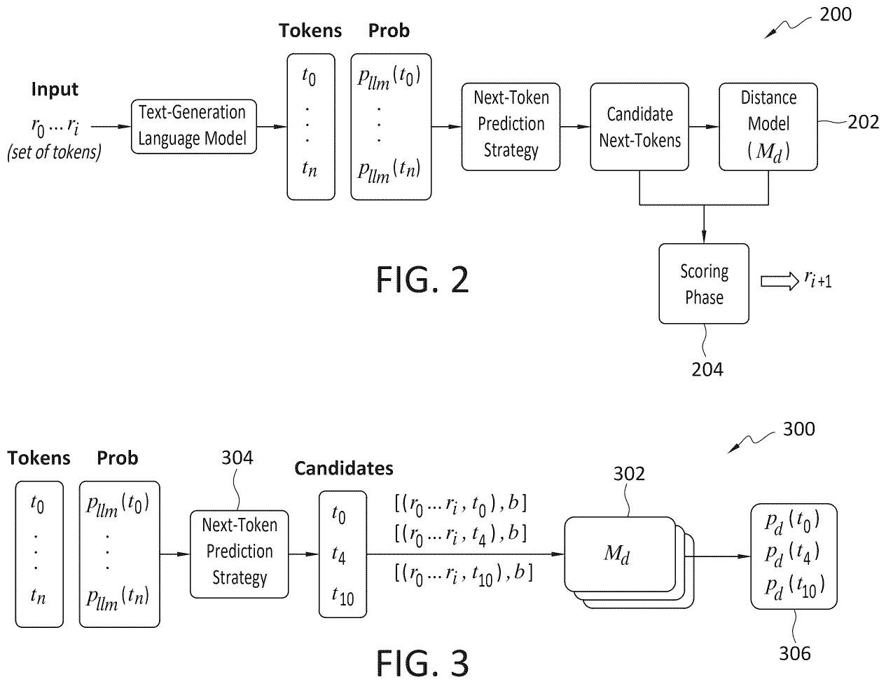

With attention now to the example of FIG. 2, an overview of aspects of a pipeline 200 and associated method according to one embodiment is provided, where such embodiment comprises a modification and improvement of a generic approach such as is disclosed in FIG. 1. Briefly, FIG. 2 discloses how one embodiment differs from a standard text-generation pipeline with the addition of, at least, (1) a Distance Model Ma 202 and (2) a scoring phase 204. Instead of having the NTPS decide the next token, an embodiment leverages Ma 202 to calculate the probability that a given token will respect a specified budget. This process may be repeated over several next-token candidates. The M_{d} 202 output probabilities alongside their LLM probability pₗₗₘ counterparts are pushed forward to the scoring phase 204 which will decide which token will be the next token.

### C.1 Distance Model

In one embodiment, a distance model M_{d} (see 202 in FIG. 2) is an LM trained offline that receives a set of tokens (rₖ . . . rᵢ, rᵢ₊₁) and a token budget (b). M_{d} outputs the probability that the selection of rᵢ₊₁, that is, the next token, will respect that token budget.

### C.1.1 Distance Model Training

In one embodiment, training of the distance model M_{d} is performed offline with a dataset generated from the same LLM, and a next-token strategy that will be used at runtime. In an embodiment, the training dataset may be built as follows:
generate several sentences using the same Text-Generation Language Model akin to the use-case—the sentences must have a varying size so the model can generalize different variations;
remove different amounts of token from the end of each sentence creating different subsets, that is, sub-sentences, from the same sentence; and
combine each sub-sentence with a varying set of realistic budgets.
   This training dataset is then used as input to train the distance model.

The ground truth for the training is, for each generated sub-sentence and budget given as input, a value of 0.0 or 1.0 expressing whether the sub-sentence does (1.0) or does not (0.0) reach an end-of-sentence token with budget tokens. In one or more alternative embodiments, the ground truth may be considered as a proximity calculation, that is, related to the number of tokens preceding an end-of-sentence token that were removed from the end of the original sentence to create the sub-sentence, generating intermediate values, that is values between 0 and 1, in the range [0 . . . 1].

Note that, in one embodiment, the training of the distance model M_{d} is bound to the specific next-token strategy used at runtime. This constraint is required because any deviation in either of those, may greatly change text generation output size. Furthermore, M_{d} word/sentence to token algorithm as well as token size should be equal to the runtime text-generation LM as to match the token budget input value.

### C.1.2 Inference Phase

At runtime, the distance model M_{d} may be expected to produce different probabilities for a set of different inputs with varying last tokens. In a conventional approach, the NTPS only chooses one definitive rᵢ₊₁ and the text generation algorithm would then move forward to the next token. For example, in a greedy strategy that would be the one with the highest probability output from the LLM. One embodiment comprises a modification and improvement to this logic. This modified logic selects a candidate set of tokens instead of only selecting a single token. Going back to the greedy strategy, one embodiment might select the top-3 highest rated tokens as candidates to be the last token.

With attention now to the example of FIG. 3, a pipeline 300 and associated method according to one embodiment is disclosed. In this example, there are 3 candidate last tokens passing through distance models which generate corresponding probabilities for each of the candidate tokens.

In more detail, the example of FIG. 3 indicates the addition of the distance model M_{d} 302 to create a modification of the pipeline 200 disclosed in FIG. 2. In one embodiment, the NTPS 304 will define several candidate tokens, namely, t₀, t₄, t₁₀ in the example of FIG. 3, which will be fed into M_{d} 302 with an available token budget (b). In the example of FIG. 3, the pipeline 300 may be optimized by having several instances of the distance model M_{d} 302 performing inferencing in parallel with each other. These instances of the distance model M_{d} 302 will each produce a respective probability 306 that will be leveraged at the scoring phase.

In one embodiment, the number of inputs to be tested may depend on the compute availability and latency of the use-case. However, in one embodiment, evaluating only a few tokens is beneficial as the candidate tokens are the only ones considered to be, potentially, the next token. Keeping only the highest rated tokens decreases the likelihood of selecting a token that will respect the budget but break sentence coherence.

### C.2 Scoring Phase

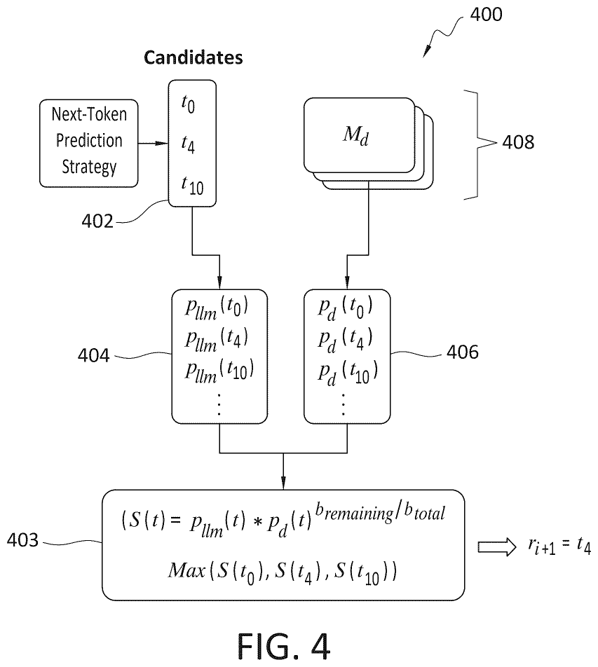

In an embodiment, the scoring phase selects which token will be defined as rᵢ₊₁ before continuing to rᵢ₊₂. FIG. 4 discloses an example embodiment of a pipeline 400 for scoring the tokens, and selecting a next token. In particular, the score is computed for each of the candidate tokens 402 selected by the NTPS, as noted above in the discussion of FIG. 3. Each score 403 will use the LLM probabilities pₗₗₘ 404 of the tokens and the probabilities p_{d} 406 generated as part of respective inference phases by the instances of the distance model M_{d} 408 as follows:

$$S ( t ) = {p}_{llm} ( t ) * {{p}_{d} ( t )}^{{b}_{remaning} / {b}_{total}}$$

It is noted that p_{d} is powered by the percentage of the remaining budget (b) of the total budget (b). In this way, as the remaining budget decreases, the score moves towards picking the most likely token to finish the sentence, moving the entire text generation towards completing the sentence as soon as possible, but still preserving coherence by leveraging the NTPS selection and original LLM probabilities.

With continued reference to FIG. 4, rᵢ₊₁ will receive the token t with the maximum score out of all evaluated candidate tokens. In the example of FIG. 4, the token t₄ is the highest scoring token. As an optimization enhancement, a text-generation system may start using the example embodiment disclosed in FIGS. 3 and 4 when the token budget reaches a specific threshold such as “only 30 tokens left” or “only 5% of the budget remaining.” In this way, the system will start to sway over and go towards completing the sentence. Otherwise, the impact on the score may be marginal. Another available optimization is to only call M_{d} on discrete budget values such as 30, 20, 10 and so forth. In one embodiment, the combination of these optimization enhancements will greatly minimize the impact of the embodiment on the text-generation latency.

### D. EXAMPLE EMBODIMENT IN A RUNTIME ENVIRONMENT

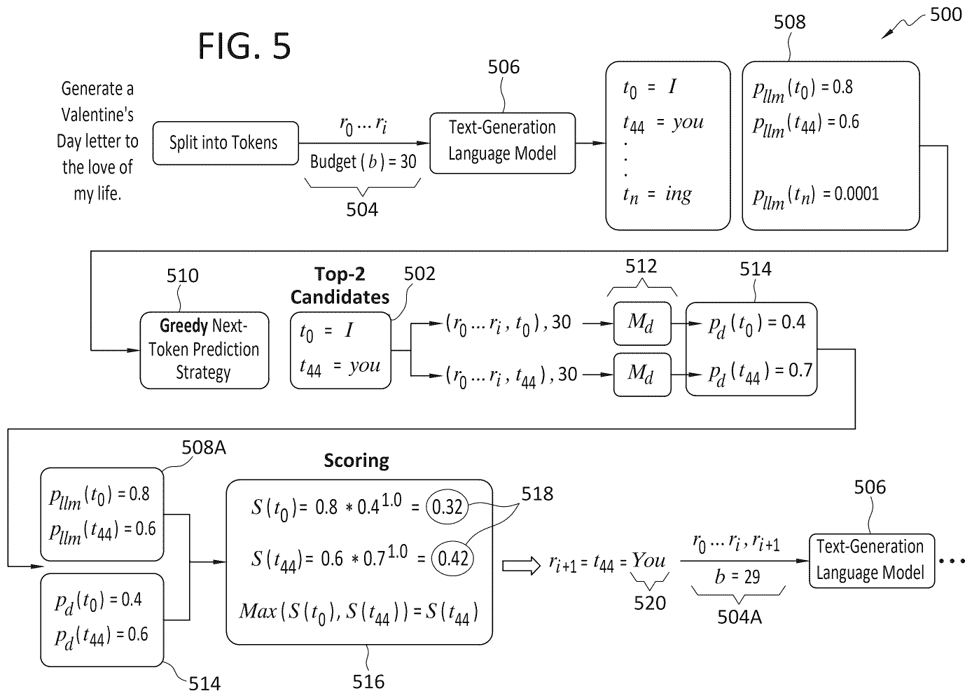

With attention now to FIG. 5, an example pipeline 500 according to one embodiment is disclosed. The example of FIG. 5 includes values of an illustrative runtime execution of the pipeline 500. This example embodiment uses a greedy next-token prediction strategy selecting the top 2 candidate tokens 502 with a user defined budget 504 of 30 tokens. It is noted that the following discussion omits some elements, such as embeddings, in the interest of simplifying the disclosed example.

Initially, the text-generation LM 506 will produce a list of probabilities 508 of each available token. Then, the greedy next-token prediction strategy 510 will select the top 2 tokens 502 with the highest probability (t₀, t₄₄). These tokens 502 will be provided together as inputs into the distance model instances M_{d} 512 that then compute a respective probability 514 that each token 502 will respect the budget of 30. Finally, in a scoring process 516, the text-generation LM 506 original probabilities 508A and the probabilities 514 produced by M_{d} 512 may be leveraged, that is, multiplied as shown at 516, to generate the score 518 that may then be used to determine the next token. In the example, the token You 520 was selected. The selected token rᵢ₊₁ is then attached to the input, the budget 504A is decreased by one and the pipeline is repeated for rᵢ₊₂ until the end-of-sentence token is reached.

### E. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### F. FURTHER EXAMPLE EMBODIMENTS

Following are some further example embodiments. These are presented only by way of example and are not intended to limit the scope of this disclosure or the claims in any way.

Embodiment 1. A method, comprising: receiving a set of input tokens; generating, using a text generation LM (language model), respective first probabilities, for each of the input tokens, that the input token will be a next token in a text string; selecting, based on the respective first probabilities, a set of candidate tokens from the set of input tokens, and the set of candidate tokens is smaller than the set of input tokens; inputting the candidate tokens to a distance model; generating, by the distance model, respective second probabilities for each of the candidate tokens, where each of the second probabilities is a probability that a corresponding one of the candidate tokens can be added to the text string without exceeding a token budget for that text string; performing, using the first probabilities and the second probabilities, a scoring phase to compute a score for each of the candidate tokens; and selecting the token with a highest score to be added as the next token in the text string.

Embodiment 2. The method as recited in any preceding embodiment, wherein the text string comprises a sentence.

Embodiment 3. The method as recited in any preceding embodiment, wherein a last token in the text string is selected such that the token budget is not exceeded, and the text string is coherent.

Embodiment 4. The method as recited in any preceding embodiment, wherein the set of candidate tokens is selected from a larger set of tokens that were generated.

Embodiment 5. The method as recited in any preceding embodiment, wherein the scoring phase comprises, for each of the candidate tokens, multiplying the first probability by the second probability to obtain the score for that candidate token.

Embodiment 6. The method as recited in any preceding embodiment, wherein one or more subsequent next tokens are only added to the text string after addition of the next token if doing so does not cause the token budget to be exceeded and if coherence of the text string is maintained.

Embodiment 7. The method as recited in embodiment 6, wherein a final one of the one or more subsequent next tokens comprises an end-of-sentence token.

Embodiment 8. The method as recited in any preceding embodiment, wherein the token budget is not a sole determinant of whether the next token will be added to the text string.

Embodiment 9. The method as recited in any preceding embodiment, wherein the set of candidate tokens is selected using a greedy next-token prediction approach.

Embodiment 10. The method as recited in any preceding embodiment, wherein the scoring phase comprises, for each of the candidate tokens, obtaining the scope for that candidate token by multiplying the first probability for that candidate token with the second probability for that candidate token.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

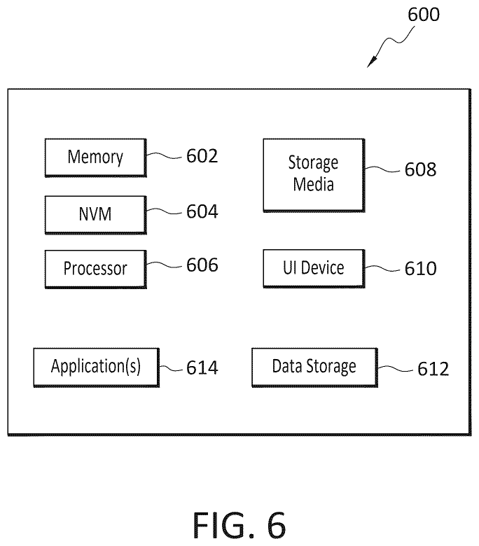

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving a set of input tokens;
generating, using a text generation LM (language model), respective first probabilities, for each of the input tokens, that the input token will be a next token in a text string;
selecting, based on the respective first probabilities, a set of candidate tokens from the set of input tokens, and the set of candidate tokens is smaller than the set of input tokens;
inputting the candidate tokens to a distance model;
generating, by the distance model, respective second probabilities for each of the candidate tokens, where each of the second probabilities is a probability that a corresponding one of the candidate tokens can be added to the text string without exceeding a token budget for that text string;
performing, using the first probabilities and the second probabilities, a scoring phase to compute a score for each of the candidate tokens; and
selecting the token with a highest score to be added as the next token in the text string.

2. The method as recited in claim 1, wherein the text string comprises a sentence.

3. The method as recited in claim 1, wherein a last token in the text string is selected such that the token budget is not exceeded, and the text string is coherent.

4. The method as recited in claim 1, wherein the set of candidate tokens is selected from a larger set of tokens that were generated.

5. The method as recited in claim 1, wherein the scoring phase comprises, for each of the candidate tokens, multiplying the first probability by the second probability to obtain the score for that candidate token.

6. The method as recited in claim 1, wherein one or more subsequent next tokens are only added to the text string after addition of the next token if doing so does not cause the token budget to be exceeded and if coherence of the text string is maintained.

7. The method as recited in claim 6, wherein a final one of the one or more subsequent next tokens comprises an end-of-sentence token.

8. The method as recited in claim 1, wherein the token budget is not a sole determinant of whether the next token will be added to the text string.

9. The method as recited in claim 1, wherein the set of candidate tokens is selected using a greedy next-token prediction approach.

10. The method as recited in claim 1, wherein the scoring phase comprises, for each of the candidate tokens, obtaining the scope for that candidate token by multiplying the first probability for that candidate token with the second probability for that candidate token.

11. A non-transitory storage medium having stored therein instructions that are executable by one or more hardware processors to perform operations comprising:
receiving a set of input tokens;
generating, using a text generation LM (language model), respective first probabilities, for each of the input tokens, that the input token will be a next token in a text string;
selecting, based on the respective first probabilities, a set of candidate tokens from the set of input tokens, and the set of candidate tokens is smaller than the set of input tokens;
inputting the candidate tokens to a distance model;
generating, by the distance model, respective second probabilities for each of the candidate tokens, where each of the second probabilities is a probability that a corresponding one of the candidate tokens can be added to the text string without exceeding a token budget for that text string;
performing, using the first probabilities and the second probabilities, a scoring phase to compute a score for each of the candidate tokens; and
selecting the token with a highest score to be added as the next token in the text string.

12. The non-transitory storage medium as recited in claim 11, wherein the text string comprises a sentence.

13. The non-transitory storage medium as recited in claim 11, wherein a last token in the text string is selected such that the token budget is not exceeded, and the text string is coherent.

14. The non-transitory storage medium as recited in claim 11, wherein the set of candidate tokens is selected from a larger set of tokens that were generated.

15. The non-transitory storage medium as recited in claim 11, wherein the scoring phase comprises, for each of the candidate tokens, multiplying the first probability by the second probability to obtain the score for that candidate token.

16. The non-transitory storage medium as recited in claim 11, wherein one or more subsequent next tokens are only added to the text string after addition of the next token if doing so does not cause the token budget to be exceeded and if coherence of the text string is maintained.

17. The non-transitory storage medium as recited in claim 16, wherein a final one of the one or more subsequent next tokens comprises an end-of-sentence token.

18. The non-transitory storage medium as recited in claim 11, wherein the token budget is not a sole determinant of whether the next token will be added to the text string.

19. The non-transitory storage medium as recited in claim 11, wherein the set of candidate tokens is selected using a greedy next-token prediction approach.

20. The non-transitory storage medium as recited in claim 11, wherein the scoring phase comprises, for each of the candidate tokens, obtaining the scope for that candidate token by multiplying the first probability for that candidate token with the second probability for that candidate token.
